(19) United States
(12) Patent Application Publication
(10) Pub. No.: US 2010/0318907 A1
(43) Pub. Date: Dec. 16, 2010

(54) AUTOMATIC INTERACTIVE RECORDING SYSTEM

(76) Inventors: Ronen KAUFMAN, RaAnana (IL); Ben Ghelibter, Herzlia (IL)

Correspondence Address: MARTIN D. MOYNIHAN d/b/a PRTSI, INC., P.O. BOX 16446, ARLINGTON, VA, 22215, US

(21) Appl. No.: 12/481,674

(22) Filed: Jun. 10, 2009

(51) Int. Cl. G06F 3/048; G06F 21/00; H04B 7/00; G06F 3/033; G06F 15/16

(52) U.S. Cl. 715/706; 726/31; 455/41.2; 345/184; 715/716; 715/832; 709/217

(57) ABSTRACT

A system and a booth for producing a media clip, providing one or more users with a recording studio experience including a computer configured to provide the users with interactive guidance through test producing and recording the media clip, the guidance being providing by user interaction with an animated facsimile of a recording director displayed on the display. A method for producing a media clip, providing one or more users with a recording studio experience, including providing the users with interactive guidance through test producing and/or recording a media clip, the guidance being providing by interaction with a display of an animated facsimile of a recording director, recording a media clip of the users' choice, providing the recording to the users. Related apparatus and methods are also described.

### FIELD AND BACKGROUND OF THE INVENTION

The present invention, in some embodiments thereof, relates to recording devices, and more particularly, but not exclusively, to an interactive, automatic recording booth.

There are systems today which record songs, as well as booths into which a user can enter, sing a song and record the song, and produce a CD. Some example systems include a system from Daeseung Intercom Co., Ltd., of Korea, and the Papa Karaoke Kiosk from Papa Technologies of Thailand.

An example system includes a TV screen, a Karaoke amplifier, two microphones, a PC and software, a control panel, a coin selector, and a speaker.

Background art includes:

U.S. Pat. No. 6,086,380 to Chu et al.; and

US Published Patent Application 2008/0198271 of Malki.

### SUMMARY OF THE INVENTION

The present invention, in some embodiments thereof, relates to recording devices, and more particularly, but not exclusively, to an interactive, user-operated recording booth. Optionally, the booth is at least semi-automatic.

Exemplary embodiments of the invention include an automatic interactive recording system providing one or more users with a recording studio experience, recording an audio performance including optional accompanying playback from a collection of prior recordings. In an exemplary embodiment of the invention, the user experiences an interactive guided recording process, optionally receiving guidance through one or more of recorded voice, gestures from an animated image, prompter text, lights, and on-screen GUI.

An exemplary embodiment of the invention includes a recording booth, able to contain one or more users, and designed so as to deaden external noises.

In an exemplary embodiment of the invention, the users enter the recording booth, and are welcomed by an animation of, for example, a recording director, and guided through a process of recording a media clip (or other activity) by the animation. Optionally, the guidance is provided differently for users which indicate that they are first time users and users which already know the workflow.

An aspect of some embodiments of the invention relates to a workflow including a test recording, in which the user acts as a recording artist and sound technician, sets sound parameters, and performs one or more test playbacks before optionally recording the media clip.

An exemplary embodiment of the invention provides a user with a take away product. The take away product includes, for example, one or more of a recorded optical disc, a package for the optical disc, sending a digital recording to a Bluetooth device, storing the digital recording on various memory devices such as a disk-on-key or memory cards, and sending the digital recording to an email address or internet address (URL).

An aspect of some embodiments of the invention relates to one or more automatic interactive recording systems, and a central management unit. The central management unit optionally provides remote control of the automatic interactive recording systems, enabling a business model in which a commercial enterprise may optionally leases out the automatic interactive recording systems and/or operate a number of the automatic interactive recording systems; optionally retaining control of payments, and/or royalty distributions, and/or number of recordings made in the automatic interactive recording system.

An aspect of some embodiments of the invention relates to a business model in which one or more of the interactive recording systems being provided for use at special events, and a mobile booth being provided which can be quickly placed at the special event. The event is termed a “Beatbox Event”. In a Beatbox Event one or more interactive recording systems are provided, typically leased or rented, to organizers of an event. The automatic interactive recording system is placed so that event participants use the system, for free, and/or for tokens which the event participants receive. The business model includes the payment for use of the interactive recording systems passing from the organizers of the event to the providers of the interactive recording systems regardless of whether payment is paid by users of the interactive recording systems.

Some of the embodiments of the invention relating to the Beatbox Event are optionally configured as “plug and play” embodiments. The “plug and play” aspect includes the interactive recording system being ready for use when it has been plugged into electric power.

Optionally, the “plug and play” embodiment does not require a network connection.

Optionally, the “plug and play” embodiment does not require a pile of CDs for accompaniment media clips, as the media clips are included in the interactive recording systems.

Optionally, the “plug and play” embodiment does not require a sound technician or a recording director for providing users with a recording studio experience, since it uses an interactive animation of, for example, a recording director, to guide users through a process of recording a media clip.

Optionally, the interactive recording system, both in a “plug and play” embodiment and in other embodiments, includes a projector for projecting the interactive animation and/or an image of the users outside a booth.

Optionally, the interactive recording system, both in a “plug and play” embodiment and in other embodiments, includes a loudspeaker for sounding a media clip and sound of the user outside a booth.

According to an aspect of some embodiments of the present invention there is provided a booth for producing a media clip, providing one or more users with a recording studio experience including a computer configured to provide the users with interactive guidance through test producing and recording the media clip, the guidance being providing by user interaction with an animated facsimile of a recording director displayed on the display.

According to some embodiments of the invention, further including a sound playing device, a display, a user interface, and a recording device, and the computer is further configured to record the media clip on the recording device and provide the recording to the users.

According to some embodiments of the invention, further including a user interface including analog controls. According to some embodiments of the invention, the analog controls include a rotating knob. According to some embodiments of the invention, the analog controls include a slider potentiometer.

According to some embodiments of the invention, further including a payment collection system.

According to some embodiments of the invention, the animated facsimile includes a flash video animation.

According to some embodiments of the invention, further including a Bluetooth communication unit, and the providing the recording includes sending the recording to a Bluetooth device.

According to some embodiments of the invention, further including a digital disc recording unit, and the providing the recording includes digitally transferring the recording to a disc and providing the disc to the users.

According to some embodiments of the invention, the computer is configured to provide the users with interactive guidance for adjusting parameters to improve quality of the media clip and test producing the media clip. According to some embodiments of the invention, a number of test productions is limited. According to some embodiments of the invention, the time allotted for recording and for re-recordings is limited.

According to some embodiments of the invention, further including a quality testing unit configured to provide feedback on a quality of a recorded media clip, in which the adjusted recording parameters include automatically adjusted recording parameters, automatically adjusted by the computer based, at least in part, on the feedback from the quality testing unit.

According to some embodiments of the invention, the automatically adjusted parameters include a playback track volume for each playback track.

According to some embodiments of the invention, further including a central management unit connected by network to the computer.

According to some embodiments of the invention, the central management unit is configured to block the media clips from being produced at the booth. According to some embodiments of the invention, the central management is configured to set a limit to a number of media clips produced at the booth.

According to an aspect of some embodiments of the present invention there is provided a system for producing a media clip, providing one or more users with a recording studio experience including a computer configured to provide the users with interactive guidance through test producing and recording the media clip, the guidance being providing by user interaction with an animated facsimile of a recording director displayed on the display.

According to an aspect of some embodiments of the present invention there is provided a method for producing a media clip, providing one or more users with a recording studio experience, including providing the users with interactive guidance through test producing and recording a media clip, the guidance being providing by interaction with a display of an animated facsimile of a recording director, recording a media clip of the users' choice, and providing the recording to the users.

According to some embodiments of the invention, further including using a booth for the producing.

According to some embodiments of the invention, further including, before the recording, performing one or more test productions for testing quality of the sound of the media clip, and optionally guiding the users through one or more test productions for testing quality of the sound with adjusted parameters.

According to some embodiments of the invention, further including providing a first-time user with different interactive guidance than a user familiar with the method for producing a media clip.

According to some embodiments of the invention, guiding the users through one or more test productions is performed until a specific quality of the recording is achieved. According to some embodiments of the invention, a number of the test productions is limited.

According to some embodiments of the invention, the adjusted parameters include automatically adjusted parameters. According to some embodiments of the invention, the automatically adjusted parameters include playback track volume for each playback track.

According to some embodiments of the invention, the adjusted parameters include one or more of the group including input volume, playback volume, and total volume. According to some embodiments of the invention, the adjusted parameters include special effects.

According to some embodiments of the invention, the providing the recording to the users includes sending the recording via a Bluetooth connection to a user's Bluetooth enabled device.

According to some embodiments of the invention, the providing the recording to the users includes producing a digital disc and providing the digital disc to the users.

According to some embodiments of the invention, further including providing a sound insulating compartment in which to produce the media clip, wherein the display of the animated facsimile of a recording director appears to be behind a glass window.

According to some embodiments of the invention, further including using a central management computer for remotely managing the booth. According to some embodiments of the invention, the central management includes blocking the booth from producing the media clips. According to some embodiments of the invention, the central management includes setting a limit to a number of media clips produced by the booth.

According to some embodiments of the invention, the central management includes communicating with the booth over a network.

According to some embodiments of the invention, the central management includes reading codes from the booth. According to some embodiments of the invention, the central management includes sending codes to the booth.

According to some embodiments of the invention, the central management includes providing codes for entering to the booth.

According to some embodiments of the invention, the central management includes one or more functions from the group including payment monitoring, gathering data about users, gathering data about media clips, blocking the system for producing a media clip from use, changing a number of uses allowed the system for producing a media clip, updating media clips stored by the system for producing a media clip, updating programming of the system for producing a media clip, gathering data about status of components of the system for producing a media clip, and sending advertising for display by the system for producing a media clip.

According to an aspect of some embodiments of the present invention there is provided a method for producing a media clip, providing one or more users with a recording studio experience, including providing the users with interactive guidance through test producing the media clip, the guidance being providing by interaction with a display of an animated facsimile of a recording director.

According to an aspect of some embodiments of the present invention there is provided a method for providing a recording studio experience for participants of an event, including placing the booth of claim 1 at the event and enabling the participants of the event to be users of the booth.

According to some embodiments of the invention, use of the booth is provided free of charge to the participants of the event.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings and images. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is an image of an example embodiment of a recording booth placed in a shopping mall environment;

FIG. 2 is an image of a model of an example embodiment of a booth and interactive recording system constructed according to the present invention;

FIG. 3A is an image of a prior art recording artist room in an example recording studio;

FIG. 3B is an image of a prior art recording director's room in the example recording studio of FIG. 3A;

FIG. 3C is a screen capture from a display of a model of an interactive recording system operational according to the present invention;

FIG. 4A is a simplified flowchart of a method of operation of an example embodiment of the invention;

FIG. 4B is a simplified flowchart of a method of operation of an alternative example embodiment of the invention;

FIG. 4C is a simplified flowchart of a alternative method of operation of a portion of the flowchart of FIG. 4B;

FIG. 4D is a simplified flowchart of the method of FIG. 4C, applied to sending a take away product to a Bluetooth device;

FIG. 4E is a simplified flowchart of an alternative method of operation of an example embodiment of the invention;

FIG. 5A is a simplified drawing of the booth and interactive recording system of FIG. 2, drawn from a point of view depicting a user's side;

FIG. 5B is a simplified drawing of the booth and interactive recording system of FIG. 2, drawn from a point of view depicting a technical side;

FIG. 5C is a simplified side drawing of the booth and interactive recording system of FIG. 2;

FIG. 6 is a simplified block diagram of an example embodiment of an interactive recording system constructed according to the present invention;

FIG. 7 is a simplified block diagram of an example embodiment of a sound processing unit of the interactive recording system of FIG. 6;

FIG. 8 is a simplified block diagram of an example embodiment of a user control board in the interactive recording system of FIG. 6;

FIG. 9 is a simplified block diagram of an example embodiment of a central management unit connected to the interactive recording system of FIG. 6; and

FIG. 10 is a simplified block diagram of an example embodiment of a Bluetooth communication section of the interactive recording system of FIG. 6.

### DESCRIPTION OF SPECIFIC EMBODIMENTS OF THE INVENTION

The present invention, in some embodiments thereof, relates to recording devices, and more particularly, but not exclusively, to an interactive, automatic recording booth.

The present invention, in some embodiments thereof, produces a user experience similar to a flow of work in a recording studio operated and directed by human recording directors.

The present invention, in some embodiments thereof, includes an automatic interactive recording system allowing a user to record an audio and/or video performance, alone or in combination with playback from a media source, such as a media data base, whereby the user experiences an interactive process guided by an animated facsimile of a recording director, such as may be displayed on a display using flash animation.

The automatic interactive recording system, in some embodiments thereof, is included in a recording booth.

The automatic interactive recording system, in some embodiments thereof, is computer controlled, optionally by a standard computer.

A typical user experience while using an exemplary embodiment of the invention includes being guided step by step through a process of providing some information to the system, choosing a song and/or media clip to play as accompaniment, if the user so desires, singing along with the accompaniment and being guided, optionally by the animation of the recording director, in adjusting parameters of the sound and playback, and finally choosing in what form a resultant recording will be provided.

It is noted that by media clip it is meant both audio clip and a video clip. An accompaniment clip may be either an audio clip or a video clip. The accompaniment media clip optionally includes more than one playback track. The playback tracks may be audio, left and/or right stereo, MPEG layer 3, a video track, and a track including one instrument of a multi-track multi-instrument media clip. By way of a non-limiting example an accompaniment media clip may include a music-minus-one clip for accompanying with an instrument and/or voice, and a karaoke media clip with instrumental accompaniment and without voice.

A resultant media clip for recording and providing to a user optionally includes the accompaniment media clip recorded together with one or more tracks of the user's performance. The resultant media clip may optionally be recorded without an accompaniment media clip. It is noted that the resultant media clip need not necessarily be a song, the resultant media clip may be a greeting, a blessing, an announcement, and other such recorded media clips which are not necessarily songs.

Example sources for the song and/or media clip include, by way of non-limiting examples, a central data base, on a central management unit, optionally a computer external to the interactive recording system, to which the interactive recording system is connected by network; a data base stored on the interactive recording system; a CD and/or DVD carousel included in the interactive recording system; and/or a device in wireless communication with the interactive recording system, such as a Bluetooth device, say a cellular phone, within Bluetooth range of the interactive recording system; and/or a user's MP3 player.

Example embodiments of the invention obtain media clips by having a user optionally play and/or whistle a portion of the media clips, then optionally identify the media clip against a database of media clips, and optionally obtain the identified media clip.

Example embodiments of the invention include media clips designed for accompaniment and especially suited for serving as a greeting, a blessing, an announcement, and other such types of media clips. Such media clips optionally include one or more portions of the media clip being silent, for a user to fill in, and optionally one or more portions having a pre-recorded message, greeting, blessing, announcement, or the like.

The user optionally takes away from a session using the interactive recording system a recorded media clip. The recorded media clip may include audio only, and may include video which includes audio. The recorded media clip is optionally provided on a CD, a DVD, and/or as a digital file sent to a destination of the user's choice, such as a Bluetooth enabled cellular phone within Bluetooth range, an email address, and/or an Internet destination, a local disk-on-key and/or MP3 player and/or memory device via a USB connector.

The interactive recording system optionally includes an adjustable timing mechanism to control the time it takes to proceed from one stage to another in the recording process, while prompting the user by voice, and/or flashing lights, and/or a Graphical User Interface.

The present invention, in some embodiments thereof, includes the automatic interactive recording system within a booth, typically configured to be placed in public places such as malls, amusement parks, shopping centers. The booth optionally includes anchoring for anti-theft and anti-vandalism reasons. The booth is optionally sound proofed from its external environment. Some embodiments of the booth are constructed to contain one user at a time, and some embodiments are constructed to contain more than one user at a time, being intended for a party of users, up to, by way of a non-limiting example, 2, 3, 4, 5-10 users.

An aspect of some embodiments of the invention relates to advertising displays, optionally electronic advertising displays, optionally included in the booth. Advertising content optionally displayed on the electronic advertising displays may optionally be stored in the automatic interactive recording system within the booth, and/or may be pulled from or pushed from the above-mentioned computer external to the interactive recording system.

Advertisements may also, or instead, be included on the recorded media clip taken away by the user. The advertisements may be digitally included in the recorded media clip, and/or on the face of the CD and/or DVD, and/or on an envelope or jewel case packaging the CD and/or DVD. The advertisements are optionally used to increase income for an operator and/or owner of the interactive, automatic recording booth, and/or to mitigate some or all of the cost to a user of the interactive, automatic recording booth.

The interactive recording system optionally includes a payment collection system. The interactive recording system included within a booth will typically include a payment collection system. The payment collection system optionally includes one or more of: a coin collector; a token collector; a paper money collector; and an electronic transaction unit for processing electronic card transactions such as credit and/or debit card transactions, and/or club membership cards. The payment collection system, in appropriate cases such as coin and/or paper money payment, provides feedback to the user, by the user interface, how much money has been paid and how much remains to be paid.

It is noted that the interactive recording system, in some embodiments thereof, optionally works without payment at all, and in some embodiments thereof, optionally works without payment based on a setting by a central management unit and/or a code provided by a central management company and entered at the interactive recording system.

The automatic interactive recording system, in some embodiments thereof, is computer controlled, optionally by a standard computer. The automatic interactive recording system may therefore be placed in a home, for private use.

The automatic interactive recording system optionally includes words of a media clip projected onto a display, for aiding a user. The words are optionally included in a media clip which is the user's optional take away product.

In an exemplary embodiment of the invention, the automatic interactive recording system supports a period of testing the sound quality before recording a final recording for the user. The testing enables the user to listen to playback and the user's own voice through headphones, and adjust volume of the optional accompaniment playback, the microphone, and volume through the headphone, before starting to record the final recording. The interactive recording system optionally automatically compares the recording's input parameters, such as volume, to an accompanying clip's parameters, and adjusts the accompanying clip's parameters, and/or guides the user to adjust his or her input parameters. The input parameters include microphone volume, set by a single control and/or by a “graphic equalizer” multi-frequency-band control; and special effects options.

Guiding the user is optionally performed by starting with a test period, then having the user press a green light control such as a button to give a go ahead for recording, at which point a red light turns on, indicating that recording has started. Optionally the user is provided a one minute grace period during which the user may stop recording and request a re-recording.

Guiding the user is optionally performed by the animated facsimile of a recording director giving “recording director” types of voice instructions such as “Cut!”, and/or optionally by the animated facsimile of a recording director being displayed performing “recording director” type gestures.

The present invention, in some embodiments thereof, includes a user interface using any one or more of the following, optionally in combination: analog controls such as used in a recording studio, including knobs, buttons, lighted buttons, and sliders; a touch screen; voice output by the “recording director”; voice input by the user; gesture output by the “recording director”; a computer keyboard; and an electronic music keyboard.

The analog controls optionally include playback volume, microphone volume, and headphone volume. The analog controls optionally include rotating knob potentiometers and/or slider potentiometers.

The user interface, in some embodiments thereof, provides feedback and/or guidance to the user by marking controls appropriate to a present recording context by lights, optionally flashing lights.

The present invention, in some embodiments thereof, includes an optional connection to a central management unit. The connection uses, for example, one or more of: a wired network connection; an Internet connection; a wireless WiMAX; and a cellular data network connection. The connection optionally includes a primary connection and a backup option through an additional network connection of a same and/or a different type than the primary connection.

A failed connection to the central management unit is optionally set either to block operation of the interactive recording system, or specifically not to block operation of the interactive recording system.

The central management unit optionally controls use of the interactive recording system. Each of the interactive recording systems is loaded with a number of “beats”, where a “beat” typically corresponds to one use of the interactive recording system, such as one full session of recording. The central management unit optionally loads beats into an interactive recording system, thereby allowing a specified number of uses and blocking more than that number of uses. The interactive recording system optionally uses a counter to count full uses, or beats, and is blocked when the number of beats reaches the beats loaded by the central management unit. The central management unit can also optionally block, at will, an interactive recording system from additional beats, by sending the interactive recording system a block command.

The above beat control is enabled through a network. An additional method for beat control is also optionally provided. A service operator of an interactive recording system may use its user GUI to display a code indicating a status of the interactive recording system, including its beat counter. The code may optionally be read out to a person using the central management unit. The person using the central management unit may feed the code into the using the central management unit, and decipher a status of the interactive recording system, including its beat count.

The person using the central management unit may also use the central management unit to produce a second code which can be read out to the operator of the interactive recording system. The operator of the interactive recording system optionally feeds the second code into the interactive recording system using its user GUI. The second code is decoded by the interactive recording system, and can change its status, such as, by way of a non-limiting example, change its specified beat count, for example add to the beat count and enable the interactive recording system to continue working after having reached its limit.

The central management unit optionally monitors uses of the interactive recording system, collects data about the use, including information fed in by users, which media clips were used in as accompaniment, and payment data. The central management unit optionally computes statistics of the collected data.

The present invention, in some embodiments thereof, provides the user with a take-away product of the recording session. The take away product is designed to a quality recording, better than non-managed karaoke, by use of the feedback and adjustment mechanism during recording. The take away product includes a recorded media clip. The recorded media clip may include audio only, and may include video which includes audio. The recorded media clip, optionally by user selection, may include, karaoke-like, words of a song recorded on the recorded media clip.

The recorded media clip is optionally provided on a CD, a DVD, and/or as a digital file sent over a USB connection to a user's USB device, a digital file sent to a destination of the user's choice, such as a Bluetooth enabled cellular phone within Bluetooth range, an email address, and/or an Internet destination.

The digital recording format optionally includes a user-selected format from among digital audio and/or video formats. Such formats already include a large number of both lossy and lossless formats, and the number of formats is expected to grow in the future. The interactive recording system is configured to support present day formats, and support adding formats by updating firmware, including updating over a network initiated by the central management unit.

The CD or DVD optionally provided as a take away product optionally includes: an envelope, a jewel case, or a plastic case, optionally with a title printed thereon, and/or optional advertisement.

An optional part of the interactive recording system, and/or an optional part of the booth, includes a robotic device including a CD/DVD magazine and a CD/DVD burner. The robotic device produces CDs/DVDs of files which are sent to the robotic device from a recording computer, burning the files on the CD/DVD and discharging the CD/VD disks through a conveyor to the user.

In exemplary embodiments of the invention, the robotic device is a stand-alone magazine-fed CD/DVD burner, which accepts the media clip from a computer and records the media clip on disk. The stand-alone magazine-fed CD/DVD burner is expected to be more reliable mechanically than a robotic arm feeding discs into a standard CD/DVD burner in a standard computer.

The interactive recording system optionally searches all Bluetooth devices in Bluetooth connectivity radius, or only in a booth, and enables the user to send a recorded file to a Bluetooth system chosen by the user. As mentioned above, the Bluetooth connection also optionally enables the interactive recording system to import image files, video files, and/or music files, from the Bluetooth system chosen by the user.

The present invention, in some embodiments thereof, is configured to use a variety of connections for communicating with a user's electronic storage devices. The communication may be for importing media clips, as mentioned above, and/or for providing the take away product. Connections supported by embodiments of the invention include, by way of a non-limiting example, Bluetooth, USB, and connection to a variety of memory cards such as, again by way of a non-limiting example, CompactFlash I (CF-I), CompactFlash II (CF-II), SmartMedia (SM/SMC), Multimedia Card (MMC), Secure Digital card (SD), and xD-Picture Card (xD).

The present invention, in some embodiments thereof, is configured to provide optional copyright protection. When used, the copyright protection includes optionally reporting to the central management unit when a copyrighted media clip has been played and/or recorded, for purpose of optionally passing along royalties, and/or includes Digital Rights Management (DRM) included in the media clip.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

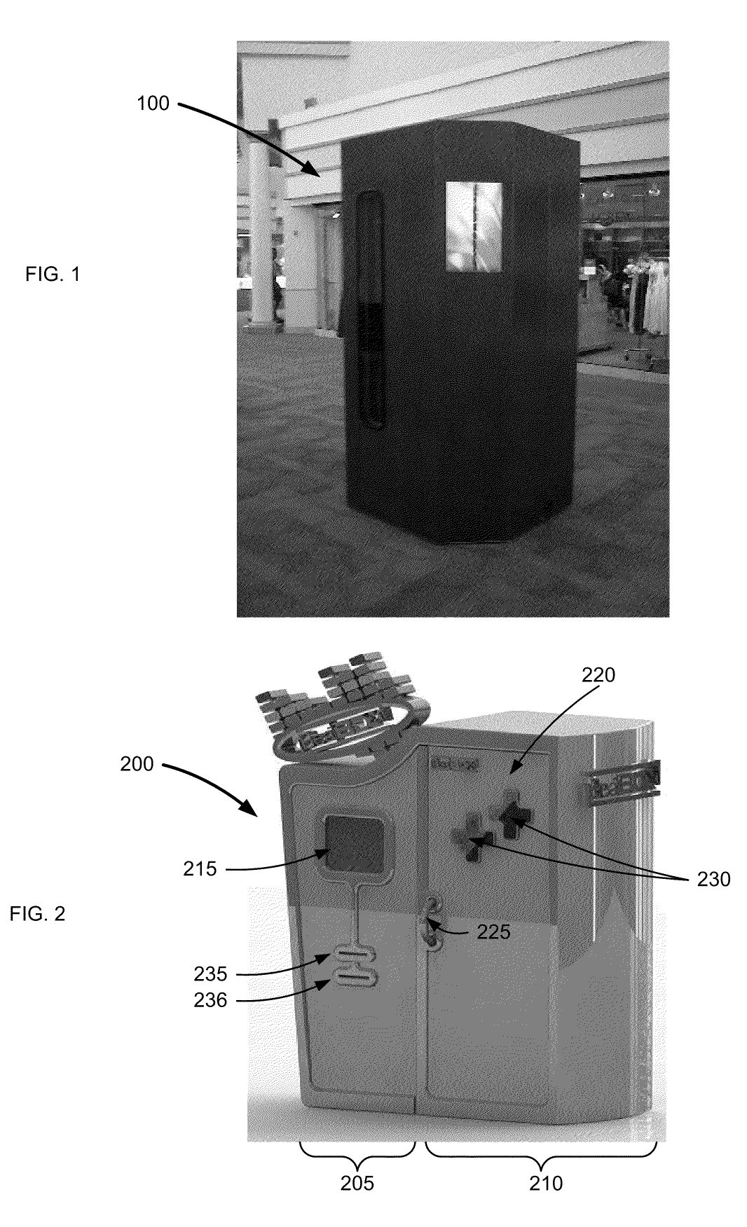

Reference is now made to FIG. 1, which is an image of an example embodiment of a recording booth 100 placed in a shopping mall environment. The karaoke booth 100 is depicted as an example of placing a recording booth in a public location.

Reference is now made to FIG. 2, which is an image of a model of an example embodiment of a booth 200 and interactive recording system constructed according to the present invention.

FIG. 2 depicts a model of an example embodiment of the invention which includes a booth 200.

The booth 200 is optionally divided into two sections: a technical section 205 for housing technical components of the interactive recording system, and a user section 210 designed as a recording booth or recording studio for users to enter.

As described above, the booth 200 optionally includes an electronic advertising display 215. It is noted that more than one electronic advertising display may be included in the booth 200, and that the model depicted is not intended to limit the invention by displaying one electronic advertising display.

The user section 210 includes a door 220, a door handle, and one or more windows 230. At least the user section 210 is optionally sound-deadened. The optional sound-deadening lessens possible effect of external sounds on recording. The sound-deadening is achieved by passive soundproofing and/or active noise cancellation at one or more microphones and/or one or more headphones.

The booth 200 optionally includes a disc dispensing slot 235, and a disc package dispensing slot 236. The disc package dispensing slot 236 depicted in FIG. 2 is optionally a slot sized for an envelope sized to package a disc such as a CD and/or DVD. The envelope is designed to optionally include printing thereon. The printing optionally includes a name of the media clip and optionally includes advertising and/or branding.

It is noted that example embodiments of the invention provide one or more users with a recording studio experience of recording an audio performance. To that end, it is desired that the booth 200 optionally have an interior design like a recording studio, and optionally be made to feel as if viewing an image of a “recording director” through a “glass window”, as is the case in actual recording studios.

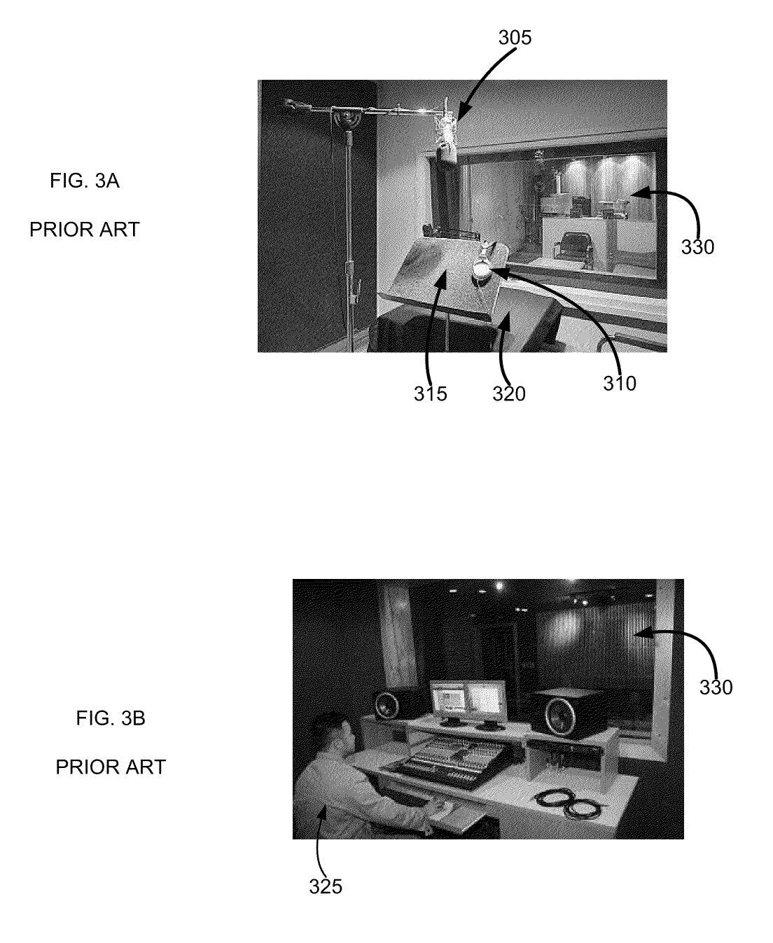

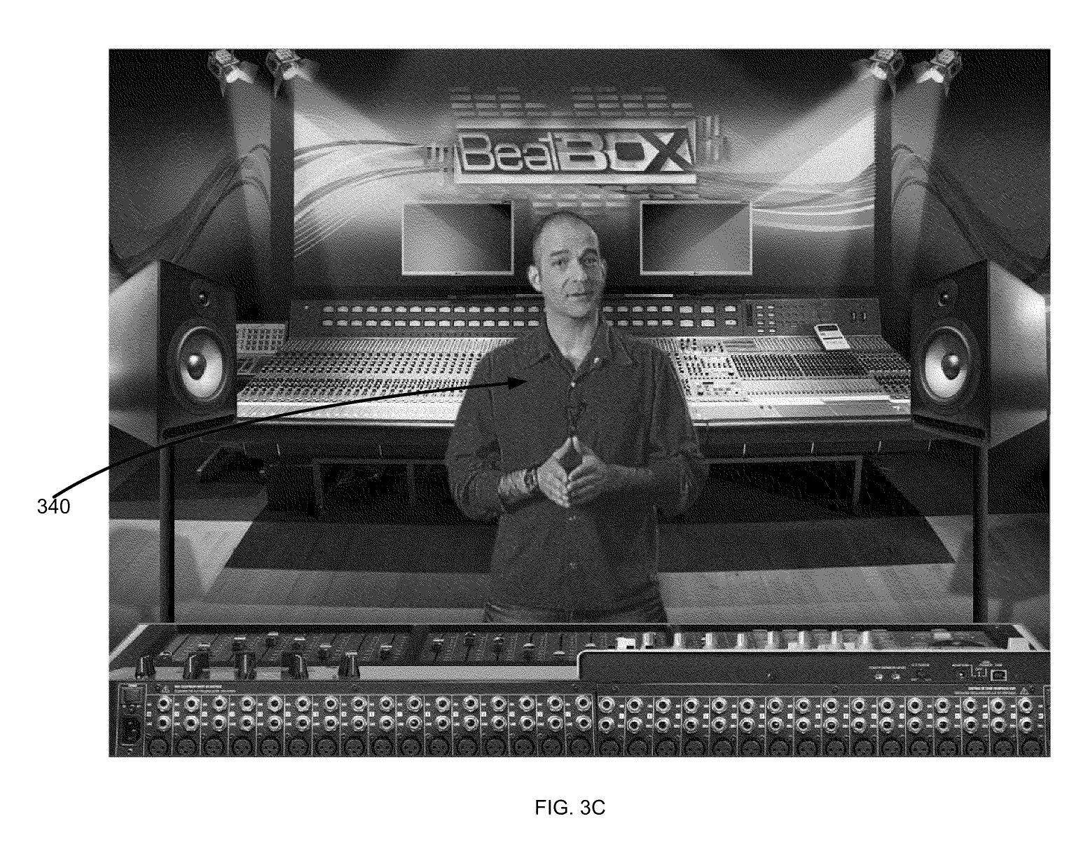

Reference is now additionally made to FIG. 3A, which is an image of a prior art recording artist room in an example recording studio. The booth 200 (FIG. 2) optionally includes one or more microphones, such as a microphone 305 depicted in FIG. 3A; one or more headphones, such as a headphone 310 depicted in FIG. 3A; and a desk and/or note stand such as a note stand 315 and a desk 320 depicted in FIG. 3A.

Reference is now additionally made to FIG. 3B, which is an image of a prior art recording director's room in the example recording studio of FIG. 3A.

The booth 200 of FIG. 2 includes hardware performing at least some of the functions typically performed by the hardware depicted in FIG. 3B, and does not include a recording director such as a person 325 depicted in FIG. 3B.

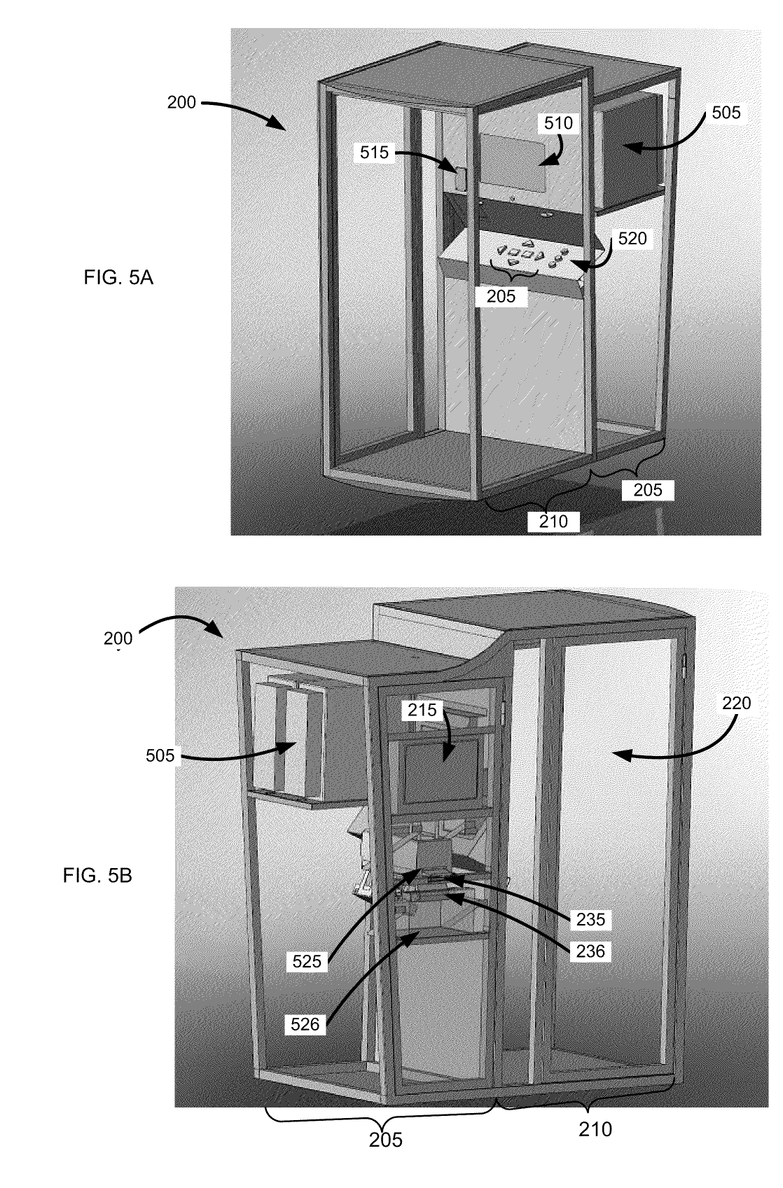

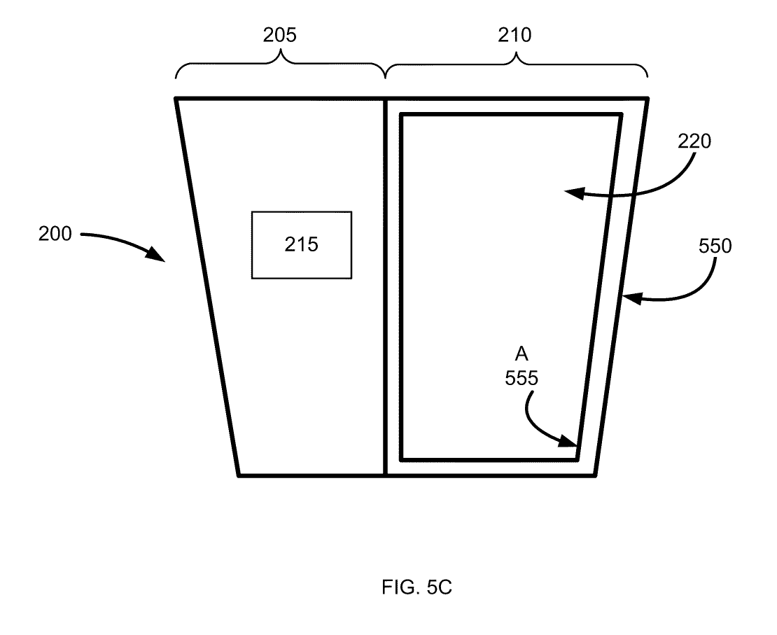

The booth 200 optionally has an electronic display (described below with reference to FIG. 5A) which optionally displays an image of a window 330 (depicted in FIGS. 3A and 3B) through which may be seen a recording director's room such as depicted in FIG. 2B. The electronic display optionally also displays a facsimile of a recording director, optionally displayed using flash animation.

Reference is now additionally made to FIG. 3C, which is a screen capture from a display of a model of an interactive recording system operational according to the present invention.

FIG. 3C indeed depicts a facsimile of a recording director 340, optionally displayed using a flash video format (FLV), and the image of FIG. 3C represent a view through the window 330.

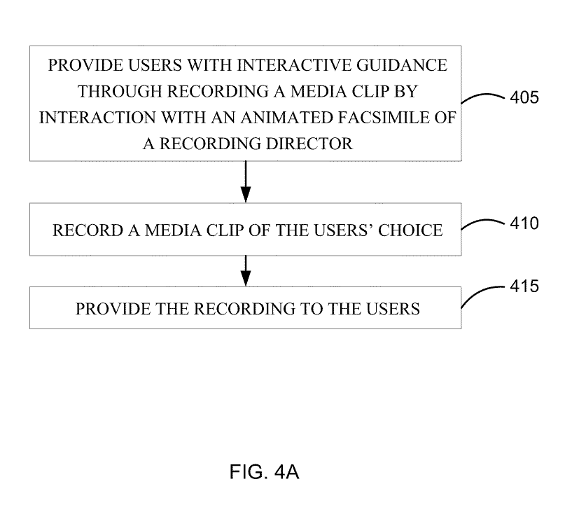

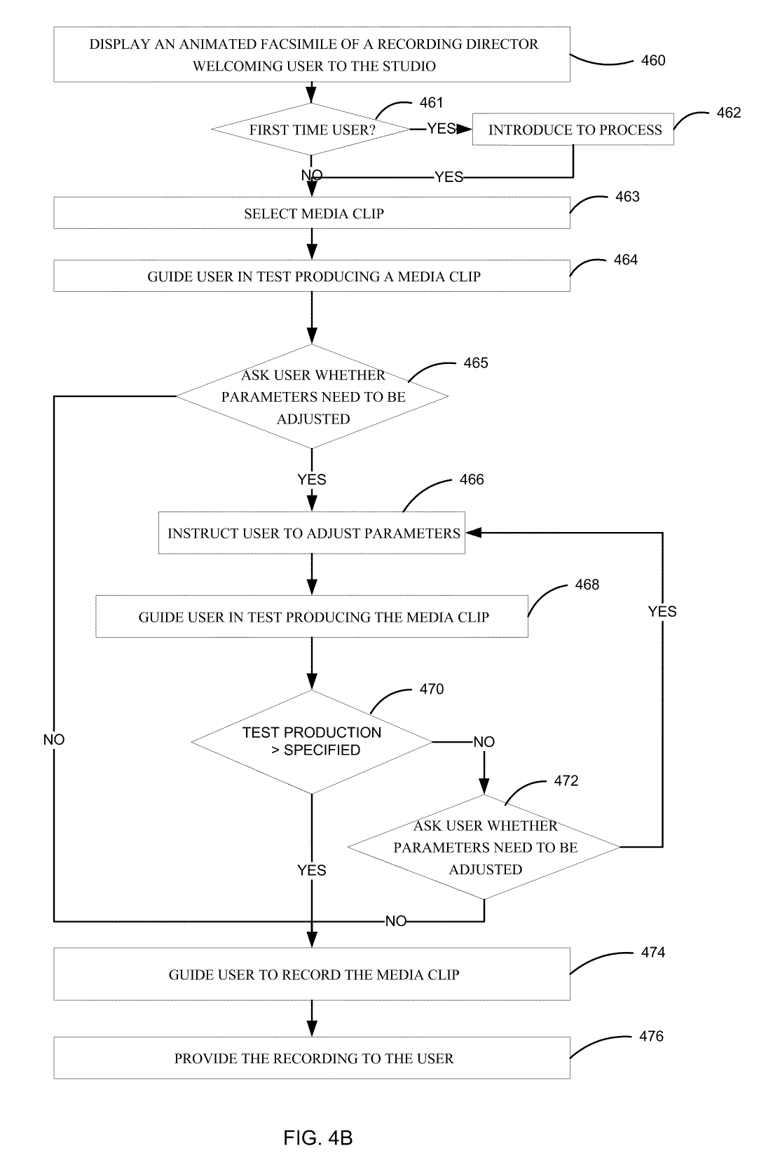

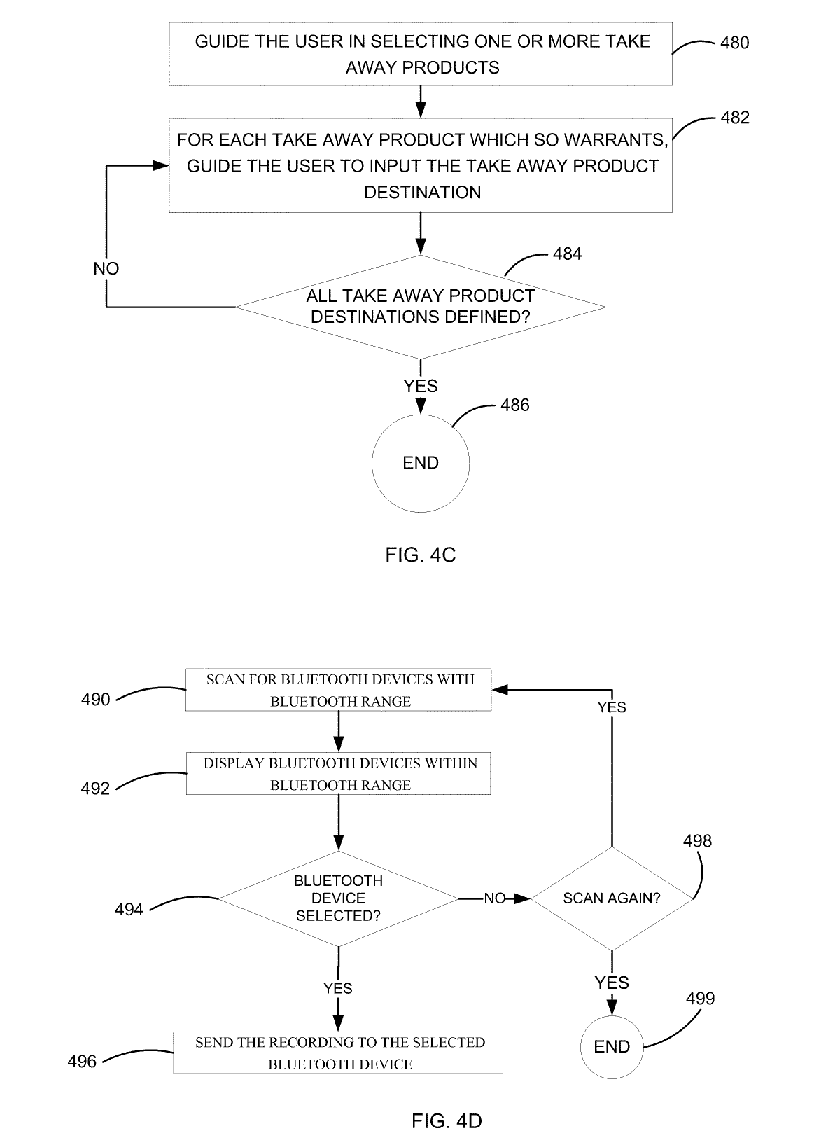

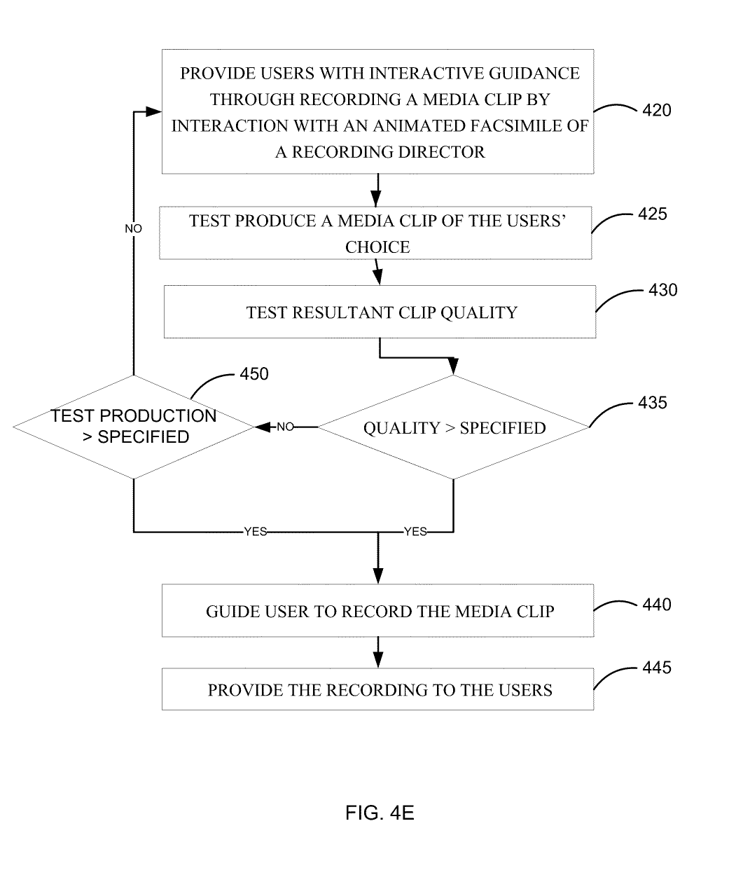

Reference is now made to FIG. 4A, which is a simplified flowchart of a method of operation of an example embodiment of the invention.

In some exemplary embodiments, the interactive recording system provides users with interactive guidance through recording a media clip by users' interaction with an animated facsimile of a recording director (405).

The guidance guides the users through recording a media clip of the users' choice (410).

Having recorded the media clip, the interactive recording system provides the recording to the users (415).

The interactive recording system optionally includes a testing of resultant media clip quality before producing a final recording for the user. If the quality is not acceptable to the user, the interactive recording system optionally guides the user to repeat the input, such as singing, in order to record an additional media clip of better quality.

The testing enables the user to listen to playback and the user's own voice through headphones, and adjust volume of the optional accompaniment playback, the microphone, and volume through the headphone, before starting to record the final recording. The input parameters include microphone volume, set by a single control and/or by a “graphic equalizer” multi-frequency-band control; and special effects options.

In an exemplary embodiment of the invention the testing includes sending a recorded media clip to as user's cell phone, by way of a non-limiting example through a Bluetooth connection and/or a USB connection. The user plays back and listens to the recorded media clip on the cell phone, assessing the quality of the media clip. The user optionally installs an applet on the cell phone for playing back and/or for storing the media clip. The applet is also optionally used to control distribution of media clips.

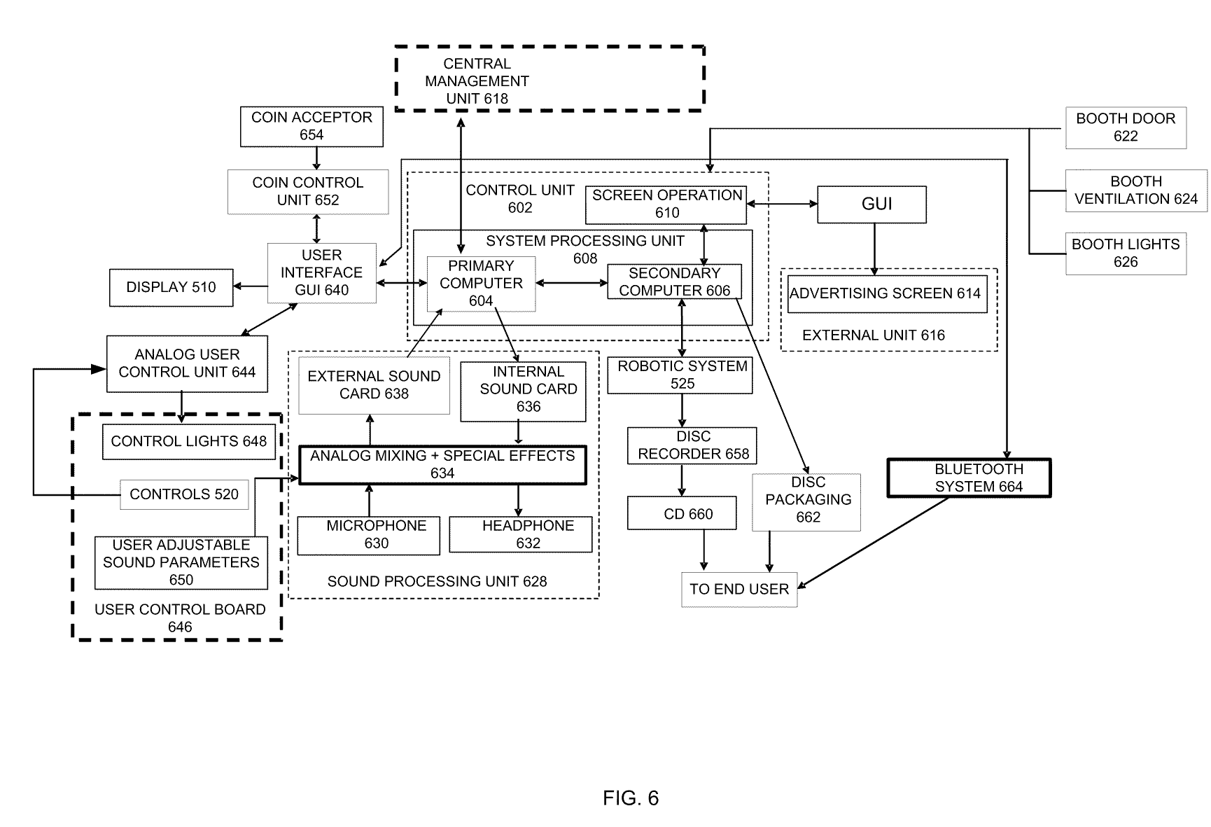

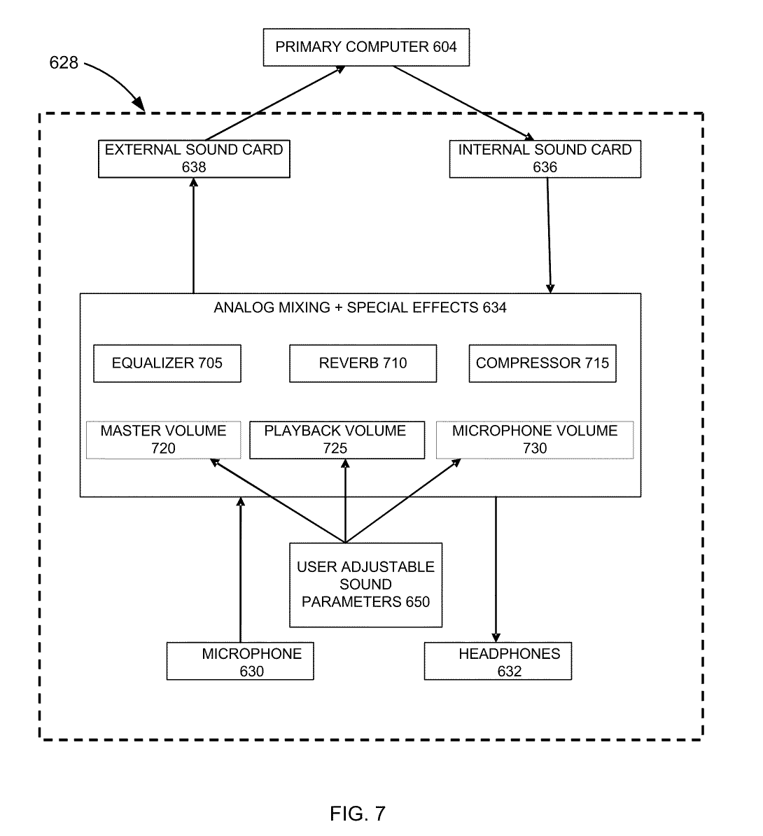

Guiding the user is optionally performed by starting with a test period, having the user press a green lighted actuator such as a button to give a go ahead for recording, at which point a red light turns on, indicating that recording has started. Optionally the user is provided a grace period during which the user may stop recording and start a re-testing and/or a re-recording. The grace period is optionally set by a service technician, as described below with reference to FIG. 6. The grace period may last, by way of a non-limiting example, for one minute.

The interactive recording system optionally includes an automatic testing, by the interactive recording system, of a media clip quality, before and/or during producing a recording for the user. If the quality is not up to a specified standard, the interactive recording system optionally guides the users to repeat their input, such as singing, in order to record an additional media clip of better quality.

The interactive recording system optionally compares input parameters to an accompanying clip's parameters, and optionally adjusts the accompanying clip's parameters for the additional recording, and/or guides the user to adjust the input parameters for the recording.

The input parameters optionally include one or more of: microphone volume, optionally set by a single control knob and/or by a “graphic equalizer” multi-frequency-band control, and optional special effects.

The accompanying clip's parameters include playback volume, optionally per playback track.

The accompanying clip may include more than one playback track. By way of a non-limiting example, an accompanying clip may include a guitar track and a drum track. Each one of the accompanying clip's tracks may be adjusted separately, and/or all together.

In an exemplary embodiment of the invention a number of controls is provided, such that, for example, a first control corresponds to a first playback track, as second control to a second playback track, and so on. In an alternative exemplary embodiment of the invention, a control is used to adjust a first playback track, then the same control is used to adjust a second playback track, then the same control is used to adjust a third playback track, and so on.

The input for recording optionally includes playing a track on a musical instrument, accompanying a music-minus-one playback clip, and optionally recording an additional track of voice. The two input tracks may be recorded at the same time, or one of the tracks added after recording the other track. The input parameters are optionally controlled separately for each of the input tracks.

Reference is now made to FIG. 4B, which is a simplified flowchart of a method of operation of an alternative example embodiment of the invention.

The alternative example embodiment of FIG. 4B includes having the above-mentioned interactive recording system:

display an animated facsimile of a recording director welcoming a user to the studio (460);

inquire whether the user is a first-time user (461);

if yes, the user is a first-time user, introduce the user to the process which is about to take place (462), then have the user select a media clip to accompany (463);

if no, the user is not a first-time user, have the user select a media clip to accompany (463);

guide the user in test producing a media clip (464);

ask the user whether recording parameters need to be adjusted (465);

if the answer is yes, that is, recording parameters need to be adjusted, then instruct the user to adjust parameters (466), else guide user to record the media clip (474);

if the answer was yes and parameters were adjusted, again guide the user in test producing the media clip (468);

check whether a number of test productions exceeds a specified number of test productions, and/or whether a total duration of test productions exceeds a specified total duration for test productions (470);

if the test production is greater than specified, guide user to record the media clip (474), else again ask the user whether recording parameters need to be adjusted (472);

if yes, the recording parameters need to be adjusted again, then instruct the user to adjust parameters (466), and proceed to guide the user through another test production, else guide user to record the media clip (474); and

after having guided the user to record the media clip (474), provide the recording to the user (476), in any one of the ways described herein to provide a take away media clip.

The user is thus allowed to sing and/or play the chosen media clip and optionally accompany the clip, and test the quality. The testing the quality may optionally be done by simply listening to the media clip and accompaniment through headphones. If the quality is not good, the user may adjust parameters and try again. The number of attempts is optionally limited.

In some embodiments of the invention a number of optional time window parameters are defined. The optional time window parameters are optional time limits set for certain processes.

A first optional time window is how long the user is allowed for selecting an accompaniment media clip (463).

A second optional time window is how long the user is allowed for test production (464, 468).

A third optional time window is how long prior to an end of the test production a warning is sounded and/or displayed. A typical setting for the third optional time window is on the order of 20 seconds.

A fourth optional time window is how long into actually recording the media clip the user is allowed to stop the actual recording and to restart recording and/or test production. A typical setting for the fourth optional time window is on the order of one minute.

The total of the interactive recording process from beginning to end has a bearing on throughput of users through the interactive recording process. A typical total is on the order of 8-12 minutes, supporting typical media clips on the order of 3-4 minutes.

A fifth optional time window is how long the interactive recording system is allotted to search for Bluetooth receivers within range.

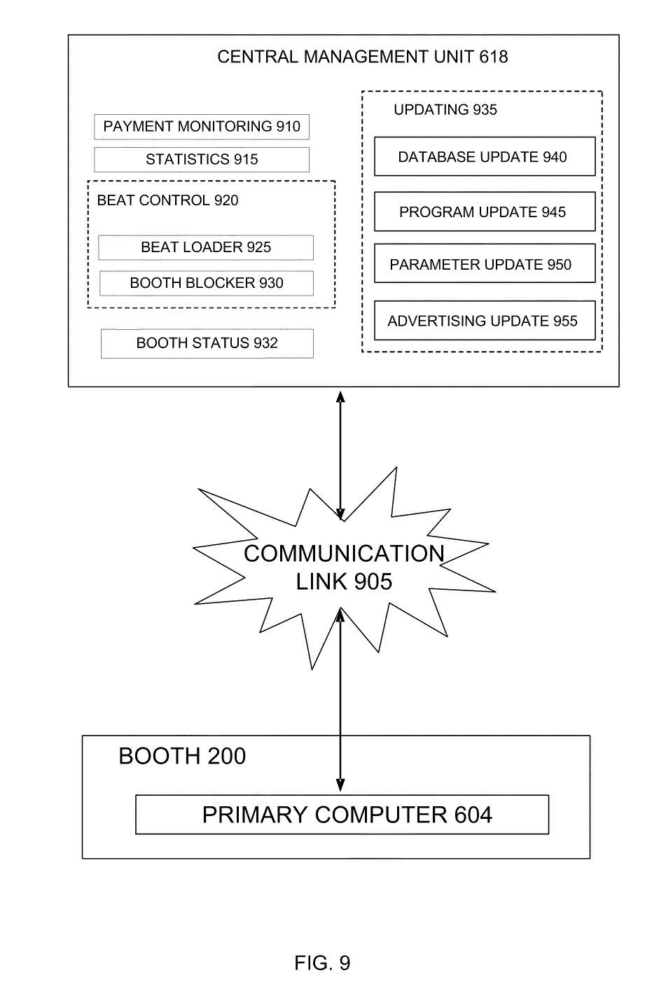

It is noted that the optional time window parameters are optionally set locally at the interactive recording system, optionally by a service technician, and/or the optional time window parameters are set by an optional central management unit, as further described below with reference to FIG. 9.

In some embodiments of the invention, providing the user with the recording requires some interaction between the user and the interactive recording system. The user is optionally offered a choice of one or more take away products. The user optionally chooses which one or more take away products to receive, such as a CD/DVD, and/or sending the recording to a network destination, and/or sending the recording to a Bluetooth receiver, and/or sending the recording to a USB device. Some of the take away products require the user to interact with the interactive recording system. By way of a non-limiting example, the interactive recording system optionally scouts which Bluetooth devices are within range, and the user selects which Bluetooth device to send the recording to. Some of the take away products do not require the user to interact with the interactive recording system, by way of a non-limiting example, providing a CD/DVD optionally does not require further interaction, as the CD/DVD are provided at the booth 200.

Reference is now made to FIG. 4C, which is a simplified flowchart of a alternative method of operation of a portion of the flowchart of FIG. 4B.

The alternative example embodiment of FIG. 4B includes having the above-mentioned interactive recording system:

guide the user in selecting one or more take away products (480);

for each take away product which so warrants, guide the user to input the take away product destination (482);

check whether all take away product destinations have been defined (484);

if yes, all take away product destinations have been defined, then that is an end (4860 for the providing the user with the recording (476 of FIG. 4B);

if no, not all take away product destinations have been defined, then guide the user to input the take away product destination (482).

Reference is now made to FIG. 4D, which is a simplified flowchart of the method of FIG. 4C, applied to sending a take away product to a Bluetooth device.

When the take away product is a Bluetooth device, the interactive recording system optionally scans for Bluetooth devices within Bluetooth range (490), optionally displays a list of which Bluetooth devices are within Bluetooth range (492), and optionally requires the user to select which of the Bluetooth devices within range the recorded media clip should be sent to. The user needs to select a Bluetooth device from the list. The interactive recording system checks whether the user has selected a Bluetooth device (494).

If the user has selected a Bluetooth device, the interactive recording system sends the media clip to the selected Bluetooth device (496).

If the user has not selected a Bluetooth device, the interactive recording system optionally offers to scan again for Bluetooth devices within range, and/or optionally suggest that the user turn on Bluetooth reception for the Bluetooth device. If the user indicates that the interactive recording system scan again, the interactive recording system optionally scans again for Bluetooth devices within Bluetooth range (490).

The interactive recording system optionally includes a parameter limiting a number of repeat scans.

The interactive recording system optionally includes a parameter setting a time window limit on repeat scans.

It is noted that the user may optionally select more than one Bluetooth device for the media clip to be sent to. The dealing with more than one Bluetooth device is optionally performed according to dealing with more than one take away product, as describes above with reference to FIG. 4C. The dealing with each one of the Bluetooth devices is optionally performed as describes with reference to FIG. 4D.

Reference is now made to FIG. 4E, which is a simplified flowchart of an alternative method of operation of an example embodiment of the invention.

As depicted in FIG. 4A, the interactive recording system provides users with interactive guidance through recording a media clip by users' interaction with an animated facsimile of a recording director (420).

The users test produces a media clip of their choice (425).

The interactive recording system tests quality of the resultant media clip (430). Testing quality of the resultant media clip may be performed, by way of a non-limiting example, by measuring total volume, by measuring volume of each separate track, is separate tracks are present, and/or compare volume of each separate track to each other.

The interactive recording system checks whether the quality of the media clip is greater than a specified standard (435).

If the quality is greater than specified, the interactive recording system guides the user to record the media clip on a takeaway recording medium such as described above (CD/DVD/memory card/Disk On Key) (440).

The interactive recording system provides the recording to the users and/or sends the media clip to a destination of the users' choosing (by Bluetooth/Internet/other network) (445).

If the quality is not greater than specified, the interactive recording system optionally checks how many times the users have test produced the media clip, and/or how much time has been spent in test production of the media clip (450).

If the number of test productions, or the time spent, is greater than a specified limit, the interactive recording system guides the user to record the media clip on a takeaway recording medium (440) and provides the recording to the users and/or sends the media clip to a destination of the users' choosing (by Bluetooth/Internet/other network) (445), and/or charges the user for another beat, that is, another session.

If the number of recordings and re-recordings is not greater than the specified limit, the interactive recording system increments a count of the number of test productions, and provides users with interactive guidance through test producing the media clip again, by users' interaction with an animated facsimile of a recording director (420). The interactive recording system optionally provides feedback to the user on what was wrong with the quality, optionally by voice guidance and/or text on a display, stating what was wrong with the quality.

Reference is now made to FIG. 5A, which is a simplified drawing of the booth 200 and interactive recording system of FIG. 2, drawn from a point of view depicting a user's side.

FIG. 5A depicts both the technical section 205 and the user section 210 of FIG. 2.

The technical section 205 is simply depicted as including a hardware unit 505, and an electronic display 510 which faces the user section 210, and which, during operation, optionally displays the image of the window 330 referred to above with reference to FIGS. 3A and 3B.

In some embodiments of the invention the booth 200 optionally includes a real window between the user section 210 and the technical section 205, and optionally the and/or an electronic display 510 recessed in the technical section 205 to provide some depth from the user section 210.

The user section 210 includes a face of the display 510, a payment slot 515, a microphone (not shown), navigation controls 517, and analog user controls 520.

Reference is now made to FIG. 5B, which is a simplified drawing of the booth 200 and interactive recording system of FIG. 2, drawn from a point of view depicting a technical side.

FIG. 5B depicts both the technical section 205 and the user section 210 of FIG. 2.

The user section 210 is simply depicted as including the door 220 of FIG. 2.

The technical section 205 includes the hardware unit 505, the optional electronic advertising display 215 of FIG. 2, a payment collection system (not shown), a robotic system 525, and a disc package dispenser 526.

The robotic system 525 optionally produces one of the optional take away products which result from a recording session. In the case of FIG. 5B, the robotic system 525 records optical discs such as CDs and/or DVDs. The robotic system 525 dispenses the optical discs through the disc dispensing slot 235 also depicted in FIG. 2. The robotic system 525 optionally senses when a small number of discs remain in a disc magazine (not shown), and warns the interactive recording system. The interactive recording system may produce an error code and/or a message sent to a central management unit such as described below with reference to FIGS. 6 and 9, so that additional discs may be supplied. The interactive recording system optionally stops operating when no more discs remain in the disc magazine, and/or provides users with a warning that a tac away product cannot be a disc.

The disc package dispensing slot 236 depicted in FIG. 2 optionally dispenses disc packages from a disc package dispenser 526, which also optionally prints on optical-disc-sized envelopes, and dispenses the envelopes through the disc package dispensing slot 236 of FIG. 2. The disc package dispenser 526 may optionally be a printer configured to dispense printout through the disc package dispensing slot 236.

In some exemplary embodiments of the invention the robotic system 525 optionally prints directly on an optical disc.

In some exemplary embodiments of the invention the disc package dispenser 526 optionally prints directly on an optical disc.

In some exemplary embodiments of the invention what is printed is optionally determined by the user. The user optionally uses a user interface and inputs text to be printed, and determines location of the text.

In some exemplary embodiments of the invention an optional camera takes a picture of the user and prints the picture.

In some exemplary embodiments of the invention an optional camera takes a video of the user, allows the user to select a still picture from the video, and prints the picture.

Reference is now made to FIG. 5C, which is a simplified side drawing of the booth and interactive recording system of FIG. 2.

FIG. 5C depicts both the technical section 205 and the user section 210 of FIG. 2.

The technical section 205 is simply depicted as including the electronic advertising display 215 of FIG. 2.

FIG. 5C depicts the user section 210 as having a wall 550 at an angle A 555 which is not a right angle to the floor of the booth 200. The wall 550 is optionally set at such an angle to the floor of the booth 200 so as to establish good acoustics in the booth 200. The acoustics are optionally intended to hinder echoes from forming in the booth 200. The angle A 555 is optionally set at about 1100, so as to direct echoes away from the microphone and/or from the facing wall. The door 220 may optionally be constructed conforming to the shape of the side of the booth 200 containing the door 220. The door 220 may optionally be constructed in a rectangular shape, not necessarily conforming to the shape of the side of the booth 200 containing the door 220.

In some embodiments of the invention the wall 550, and/or other walls of the booth 200, are constructed of materials providing good acoustics for the booth 200, sound as sound deadening materials.

Reference is now made to FIG. 6, which is a simplified block diagram of an example embodiment of an interactive recording system constructed according to the present invention.

FIG. 6 depicts, in simplified block diagram form, some units included in the interactive recording system and some units included for operating a booth operating in conjunction with the interactive recording system.

A central control unit 602 optionally includes two computers—a primary computer 604 and a secondary computer 606, in a system processing unit 608.

The primary computer 604 and the secondary computer 606 optionally communicate with each other.

In some exemplary embodiments of the invention the primary computer 604 includes a database of media clips. A typical number of media clips included in the database is on the order of ˜2500 media clips. The number of media clips depends on media clips available to operators of the interactive recording system, and on available memory space. It is noted that memory grows larger and cheaper over time.

In some exemplary embodiments of the invention the secondary computer 606 includes the database of media clips.

The secondary computer 606 is connected to a screen operation unit 610. The screen operation unit 610 optionally operates an advertising Graphical User Interface (GUI) 612 which optionally displays advertisements on an advertising screen 614, corresponding to the optional electronic advertising display 215 of FIG. 2. The GUI 612 and the advertising screen 614 are optionally included in an external unit 616, external to the booth 200 of FIGS. 2, 5A, and 5B.

In some embodiments of the invention the advertising screen 614 is divided into two areas, with one area displaying video and another area displaying advertising text.

In some embodiments of the invention the advertising screen 614 displays an “ON AIR” message on the outside of the booth 200 while recording is being performed inside the booth 200.

In some embodiments of the invention the advertising screen 614 displays an out-of-order message on the outside of the booth 200 if a diagnostic function of the booth detects that the booth is out of order, or optionally if the booth loses communication with an optional central management unit 618.

The primary computer 604 is optionally connected to a central management unit 618 optionally located remotely from the booth 200, as described above with reference to a central management unit, and described in more detail below with reference to FIG. 9.

The control unit 602 optionally provides control of some booth control units, such as: a booth door unit 622 for locking and unlocking the booth door; a booth ventilation unit, for optionally operating booth ventilation when the booth is in use; and a booth lights unit for optionally operating booth lights when the booth is in use.

The primary computer 604 is connected to a sound processing unit 628. The sound processing unit 628 includes one or more microphones 630, one or more headphones 632, a unit for analog mixing and special effects 634, a first sound card termed an internal sound card 636, and a second sound card, termed an external sound card 638. The internal sound card 636 and the external sound card 638 are described in more detail below, with reference to FIG. 7.

The primary computer 604 is connected to and operates a user interface GUI 640.

The user interface GUI 640 is connected to a display 642, corresponding to the display 510 of FIG. 5A. The user interface GUI 640 is also optionally connected to an analog user control unit 644.

The user interface GUI 640 optionally presents at least two different operation modes: one operation mode to a user, and one operation mode to a service technician servicing the interactive recording system. The technician operation mode provides access to diagnostic and maintenance functions which a user cannot access. The diagnostic functions include status of various components of the interactive recording system, interactive recording system identification numbers, and “beat” count, as described additionally below with reference to FIG. 9. The maintenance functions include, by way of a non-limiting example, setting sound parameters, as described below with reference to FIG. 7, and setting location of print on an envelope, as also described with reference to FIGS. 2 and 5B.

The analog user control unit 644 accepts input from a user control board 646. The user control board 646 optionally includes analog user controls 520 (also depicted in FIG. 5A), control lights 648, and a unit for adjusting user adjustable sound parameters 650.

The analog user controls 520 provide input to the analog user control unit 644, and via the user interface GUI 640 to the primary computer 604.

The control lights 648 optionally serve for guiding a user, by lighting up and or flashing lights by appropriate user controls, under control of the analog user control unit 644.

The unit for adjusting user adjustable sound parameters 650 is operationally connected to the unit for analog mixing and special effects 634.

The user interface GUI 640 is also optionally connected to a coin control unit 652, which is an exemplary embodiment of a payment collection system as described above. The coin control unit 652 is connected to a coin acceptor unit 654 in some exemplary embodiment of the invention the payment collection system optionally accepts tokens, paper money, and electronic transaction cards.

The coin control unit 652 updates the primary computer 604 as to payment deposited.

The secondary computer 606 is optionally connected to an optional robotic system 525 for producing one of the optional take away products which result from a recording session. The robotic system controls a disc recorder 658 which digitally records a media clip onto a CD 660 or a DVD.

The secondary computer 606 is also optionally connected to a disc packaging unit 662, which optionally prints onto a CD envelope or a jewel case. The printing optionally includes data, such as a clip name, a user name, a date, and so on, and optionally includes advertising.

As described above with reference to the take away product, other methods are contemplated for providing the media clip to the user. One such method is depicted in FIG. 6, which is a Bluetooth communication section 664 under control of the primary computer 604, which sends the media clip, via the user interface GUI 640, over a Bluetooth connection to a user's Bluetooth enabled device.

In some embodiments of the invention the optional connection of the primary computer 604 to a remote central management unit 618 is used for providing connectivity between different booths. In some embodiments of the invention users in different booths sing together, coordinated via a central unit. In some embodiments of the invention users in different booths sing in series, each one using a song track of another to sing over, coordinated via the central unit.

In some embodiments of the invention, the interactive recording system, both in a “plug and play” embodiment and in other embodiments, includes a projector (not shown) for projecting the interactive animation and/or an image of the users outside a booth. The projector optionally displays contents displayed on the display 510.

Optionally, the interactive recording system, both in a “plug and play” embodiment and in other embodiments, includes a loudspeaker for sounding a media clip and sound of the user outside a booth. The loudspeaker optionally sounds contents played through the headphone 632.

Reference is now made to FIG. 7, which is a simplified block diagram of an example embodiment of a sound processing unit 628 of the interactive recording system of FIG. 6.

The sound processing unit 628 optionally includes two sound cards, an internal sound card 636, and an external sound card 638. The internal sound card 636 and the external sound card 638 are operatively connected to the primary computer 604 of FIG. 6.

The sound processing unit 628 also includes a unit for analog mixing and special effects 634, as also depicted in FIG. 6.

The unit for analog mixing and special effects 634 accepts input from one or more microphones 630, and produces output to one or more headphones 632.

The unit for analog mixing and special effects 634 optionally includes a microphone volume unit 730; a playback volume unit 725, and a master volume unit 720. The microphone volume unit 730 optionally controls input volume from each microphone separately, or all microphones together. The playback volume unit 725 optionally controls playback volume. The master volume unit 720 optionally controls volume of the microphone or microphones together with the playback volume, controlling the volume of input sound as well as playback sound.

In an exemplary embodiment of the invention, the microphone volume unit 730, the playback volume unit 725, and the master volume unit 720 accept input from the unit for adjusting user adjustable sound parameters 650 of FIG. 6.

The unit for analog mixing and special effects 634 also optionally includes an equalizer unit 705, a reverb unit 710, and a compressor unit 715. The optional equalizer unit 705 provides an ability for the computer and optionally also for the user to control relative volume of separate frequency bands, as is known in professional sound systems. The optional reverb unit 710 provides an ability for the computer and optionally also for the user to produce the reverb special effect. The optional compressor unit 715 provides an ability for the computer and optionally also for the user to modify the dynamic range of the sound to be recorded, as is known in professional sound systems.

In an example operation of an interactive recording system constructed according to the present invention, a human sound technician uses the unit for analog mixing and special effects 634 for correcting sound parameters characteristic to the booth 200. The unit for analog mixing and special effects 634 acts as a unit termed a “mixer” in sound recording parlance. The sound technician sets initial parameters for one or more of the sub-units of the unit for analog mixing and special effects 634, so that the user, when setting user-available parameters, through the unit for adjusting user adjustable sound parameters 650, finds the acoustic environment of the booth 200 compensated for, and finds, by way of a non-limiting example, setting volume of a microphone to be naturally responsive, with little effect of booth acoustics to take care of. The initial setting of the unit for analog mixing and special effects 634 is optionally performed through an interface available to the sound technician, and optionally not available to the user.

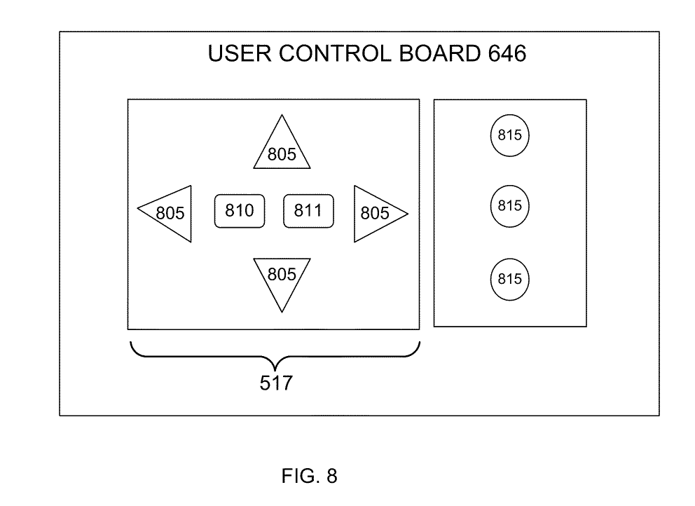

Reference is now made to FIG. 8, which is a simplified block diagram of an example embodiment of a user control board 646 in the interactive recording system of FIG. 6.

FIG. 8 depicts the user control board 646 of FIG. 6, which also corresponds to the analog user controls 520 of FIG. 5A.

The user control board 646 of FIG. 8 depicts but one exemplary embodiment of a user control board 646, and other exemplary embodiments are contemplated.

Several groups of controls are depicted in the user control board 646 of FIG. 8. A first group of controls are navigational controls 517, including a first sub-group of directional controls 805, enabling a user to optionally navigate within a menu system offered by the interactive recording system, for, by way of a non-limiting example, selecting an accompaniment media clip. The navigational controls 517 include a second sub-group of controls which are a first selection control 810 and a second selection control 811, which also aid navigation in a menu system by enabling selection of a choice using the first selection control 810, entering menu levels using the first selection control 810, and exiting from menu levels using the second selection control 811.

The a first selection control 810 is optionally red, conveying a negative sense of “stop” or “no” or “exit” or “back”, while the second selection control 811 is optionally green, conveying a positive sense of “record” or “go” or “select” or “enter” or “yes” or “confirm”.

The navigational controls 517 optionally include lights. The light of each one of the navigational controls 517 is optionally lit the one control is active, that is, when a command using the one control is allowed and/or relevant. Optionally, the light is otherwise not lit.

The navigational controls 517 comprise six controls, and are very simple to learn and use, unlike more complicated options present in existing recording systems. The navigational controls 517 also optionally enable media clip selection, including fast media clip selection by entering a media clip number. Entering numbers is optionally enables by using the up and down pointing directional controls 805 for increasing and decreasing value of a digit, and using the left and right pointing directional controls 805 for navigating left and right among digits of a multi-digit number.

An additional group of controls are analog sound controls 815. The analog sound controls 815 of FIG. 8 are depicted as rotational knobs, which are analog controls which are very familiar to users.

In alternative embodiments of the invention, the analog sound controls 815 are slider controls (not shown), which are also very familiar to users.

In yet other alternative embodiments of the invention, the electronic display 510 of FIG. 5A optionally includes a touch screen, optionally providing the functionality of the analog sound controls 815, either in addition to the analog sound controls 815 or instead of the analog sound controls 815. In still other alternative embodiments of the invention, the electronic display 510 of FIG. 5A optionally includes a touch screen, optionally providing the functionality of the navigational controls 517, either in addition to the navigational controls 517 or instead of the navigational controls 517.

Reference is now made to FIG. 9, which is a simplified block diagram of an example embodiment of a central management unit 618 connected to the interactive recording system of FIG. 6.

The central management unit 618 is connected by a communication link 905 to the primary computer 604 of FIG. 6, which is optionally located in a booth 200.

The central management unit 618 optionally performs several functions involving a central management of one or more interactive recording systems. It is contemplated that a number of booths with interactive recording systems be deployed over an area, and be managed from a central location.

The management functions are now enumerated, and involve corresponding functional units of the central management unit 618.

One optional function of the central management unit 618 is to monitor payments being made for use of the interactive recording systems, and for that function an optional payment monitoring unit 910 is provided.

One optional function of the central management unit 618 is to collect various data about use of the interactive recording systems, and for that function an optional statistics unit 915 is provided. The statistics unit optionally collects data about top media clips being used for recording, about which booths are used at what time, income per booth, tracking copyrighted material for royalty payments, and so on. All data entered into the interactive recording systems may be collected for statistical purposes, unless specifically banned by laws of the land or by a user's choice of privacy for the user's data.

One optional function of the central management unit 618 is for control of an interactive recording system, termed herein beat control. For that function an optional beat control unit 920 is provided. The beat control unit 920 optionally includes sub-units. One sub-unit is a beat loader 925, which provides an interactive recording system with permission for performing a specified number of additional recordings. The providing an interactive recording system with permission is also termed loading the booth with “beats”, where a “beat” typically corresponds to one use of the booth, such as one full session of recording. Another sub-unit is a booth blocker 930, which optionally blocks the interactive recording systems from use.

It is noted that exemplary embodiments of the invention include an optional business model for use of the interactive recording systems by a management company providing booths and/or a central management service to a second company, in which case the central management unit 618 enables the managing company to optionally constrain the second company to pay for use after a specified number of beats. The management company is enabled to load beats into an interactive recording system, and also to block an interactive recording system.

The management company is also enabled by the beat control 920 to allow a booth free use, equivalent to an unlimited number of beats. The management company is enabled by the beat control to remotely change beat policy for each individual interactive recording system.

One optional function of the central management unit 618 is to communicate with the computers in the interactive recording systems, and receive from the computers data about operational status of their subsystems, and for that function an optional booth status unit 932 is provided. The computers track subsystems such as sound cards, disc recorders, and displays as part of their normal operation, and the booth status unit 932 queries the computers and tracks their operational status. The optional booth status unit 932 also optionally tracks status of interactive recording systems, so that when such a system cannot answer a query, and/or does not send a sign of life every set period of time, the optional booth status unit 932 may assume that the interactive recording system is defective in some manner. When detecting such a defective interactive recording system, the optional booth status unit 932 optionally one or more SMS messages to relevant personnel, such as service technicians, and/or an owner or a leaser of the defective interactive recording system.

It is noted that the tracking of the computers by the central management unit 618 may optionally be performed in a “pull” fashion, where the central management unit 618 queries the computers for the status, and/or may be performed in a “push” fashion, by the computers checking their status and sending a message to the central management unit 618. The message may be a detailed status message, and/or an abbreviated message including an “OK” status or an error code.

One optional function of the central management unit 618 is to update the interactive recording systems, and for that function an optional updating unit 935 is provided. The updating unit 935 optionally includes sub-units. One optional sub-unit is a database update sub-unit 940, which updates databases of media clips present in the remote interactive recording systems.

In some embodiments of the invention, the database update sub-unit 940 includes a larger media clip database than a single one of the remote interactive recording systems, and updates the remote interactive recording systems with only part of an entire database of media clips.

In some embodiments of the invention, the database update sub-unit 940 receives recorded media clips from some or all of the remote interactive recording systems, providing a backup functionality to the media clips recorded in the remote interactive recording systems.

The database update sub-unit 940 may optionally update a status of “top ten” media clips in the remote interactive recording systems. It is noted that each of the remote interactive recording systems optionally keeps its own track of “top ten” media clips used for recording at its own booth; optionally communicates its own “top ten” media clips used for recording at its own booth to the database update sub-unit 940; and optionally updates its won “top ten” list with a “top ten” list provided by the database update sub-unit 940. It is notes that the “top ten” list provided by the database update sub-unit 940 may optionally be generated by the statistics unit 915, and/or may be manually entered by a service operator into the database update sub-unit 940 for sending to the remote interactive recording systems.

One optional sub-unit is a program update sub-unit 945, which updates programs loaded on the primary computer 604 and the secondary computer 606 of the interactive recording systems. The program updating function enables upgrading the interactive recording systems, and/or changing decor displayed on displays in the interactive recording systems, and/or changing the look of the interactive recording systems with holidays and/or changing seasons.

One optional sub-unit is a parameter update sub-unit 950. The parameter update sub-unit 950 enables the updating unit 935 to communicate with the computers in the interactive recording systems, and query the computers about parameters related to operation of the interactive recording systems. Parameters tracked by the parameter update sub-unit 950 include: cost of a “beat”; what coins may be accepted by the interactive recording systems; time allotted for the optional time window parameters described above with reference to FIG. 4B, how many test recordings are allowed; and optionally other such operational parameters optionally controlled by software.

One optional sub-unit is an advertising update sub-unit 955, which updates advertising displayed on the advertising screen 614 of FIG. 6, or the electronic advertising display 215 of FIG. 2.

In some embodiments of the invention, the interactive recording systems are optionally grouped into two or more groups for management purposes. By way of a non-limiting example, the groups may be grouped by who leases which interactive recording system. In this manner management of updating parameters, changing parameters, loading beats, blocking booths, sending service SMSs, and so on, functions which may be typically grouped by such a grouping, becomes easier. Such management is optionally performed at one time for an entire group. Another function of the grouping of the interactive recording systems is for accounting purposes. Accounting may optionally be performed per group rather than for each the interactive recording system individually. A business model guiding the accounting may optionally be different for each group.

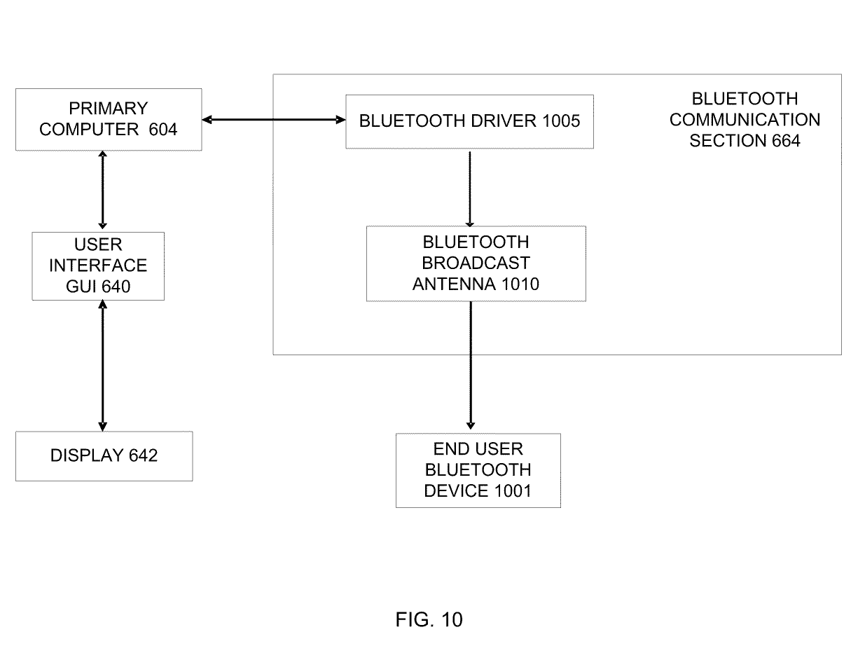

Reference is now made to FIG. 10, which is a simplified block diagram of an example embodiment of a Bluetooth communication section 664 of the interactive recording system of FIG. 6.

A user optionally commands the interactive recording system, optionally using the display 642 of FIG. 6, as a touch screen user interface GUI 640, to send the recorded media clip to a Bluetooth device 1001 which belongs to the user. The command is optionally sent to the primary computer 604, which sends appropriate instructions to a Bluetooth driver 1005.

In an alternative embodiment the user uses the navigational controls 517 to send the recorded media clip to a Bluetooth device 1001 which belongs to the user.

It is noted that whatever the user interface device used, the user may optionally use the interface device to select the Bluetooth device 1001 which belongs to the user from among more than one Bluetooth device appearing within communication range of the Bluetooth communication section 664.

The Bluetooth driver 1005 sends the recorded media clip to the Bluetooth device 1001 which belongs to the user.

It is noted that the recorded media clip is optionally sent as an MP3 file. A typical 3 megabyte MP3 media clip file optionally takes about one minute to transfer.

It is noted that the recorded media clip, when including video, may optionally be sent as an MP4 file. A typical 5-6 megabyte MP4 media clip file optionally takes about 3 minutes to transfer. When transferring recorded media clips which include video, the resolution of the video is optionally lowered for low-resolution displays, so that transfer times to Bluetooth devices such a low-resolution-display cell phones is optionally shortened.

It is noted that the Bluetooth technology is expected to advance, and transfer speeds are expected to increase, shortening media clip transfer times.

It is noted that the user may optionally need to interact with the Bluetooth device 1001 in order to get the recorded media clip onto the Bluetooth device 1001. For example, the user may have to provide a password to the Bluetooth device 1001 through the user interface GUI 640 in order to send data onto the Bluetooth device 1001.

It is expected that during the life of a patent maturing from this application many relevant media clip types, wired and wireless network types, digital recording formats, DVD formats, electronic storage devices will be developed and the scope of the terms media clip types, wired and wireless network types, digital recording formats, DVD formats, electronic storage devices is intended to include all such new technologies a priori.

The terms “comprising”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

As used herein the term “about” refers to ±10%.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A booth for producing a media clip, providing one or more users with a recording studio experience comprising a computer configured to provide the users with interactive guidance through test producing and recording the media clip, the guidance being providing by user interaction with an animated facsimile of a recording director displayed on the display.

2. The booth of claim 1 and further comprising:
a sound playing device;
a display;
a user interface; and
a recording device, and the computer is further configured to record the media clip on the recording device and provide the recording to the users.

3. The booth of claim 1 and further comprising a user interface comprising analog controls.

4. The booth of claim 3 in which the analog controls comprise a rotating knob.

5. The booth of claim 3 in which the analog controls comprise a slider potentiometer.

6. The booth of claim 1 and further comprising a payment collection system.

7. The booth of claim 1 in which the animated facsimile comprises a flash video animation.

8. The booth of claim 1 and further comprising a Bluetooth communication unit, and the providing the recording comprises sending the recording to a Bluetooth device.

9. The booth of claim 1 and further comprising a digital disc recording unit, and the providing the recording comprises digitally transferring the recording to a disc and providing the disc to the users.

10. The booth of claim 1 in which the computer is configured to provide the users with interactive guidance for adjusting parameters to improve quality of the media clip and test producing the media clip.

11. The booth of claim 10 in which a number of test productions is limited.

12. The booth of claim 10 in which the time allotted for recording and for re-recordings is limited.

13. The booth of claim 10 and further comprising a quality testing unit configured to provide feedback on a quality of a recorded media clip, in which the adjusted recording parameters comprise automatically adjusted recording parameters, automatically adjusted by the computer based, at least in part, on the feedback from the quality testing unit.

14. The booth of claim 13 in which the automatically adjusted parameters comprise a playback track volume for each playback track.

15. The booth of claim 1 and further comprising a central management unit connected by network to the computer.

16. The booth of claim 15 in which the central management unit is configured to block the media clips from being produced at the booth.

17. The booth of claim 15 in which the central management is configured to set a limit to a number of media clips produced at the booth.

18. A system for producing a media clip, providing one or more users with a recording studio experience comprising a computer configured to provide the users with interactive guidance through test producing and recording the media clip, the guidance being providing by user interaction with an animated facsimile of a recording director displayed on the display.

19. A method for producing a media clip, providing one or more users with a recording studio experience, comprising:
providing the users with interactive guidance through test producing and recording a media clip, the guidance being providing by interaction with a display of an animated facsimile of a recording director;
recording a media clip of the users' choice; and
providing the recording to the users.

20. The method of claim 19 and further comprising using a booth for the producing.

21. The method of claim 19 and further comprising, before the recording, performing one or more test productions for testing quality of the sound of the media clip, and optionally guiding the users through one or more test productions for testing quality of the sound with adjusted parameters.

22. The method of claim 21 and further comprising providing a first-time user with different interactive guidance than a user familiar with the method for producing a media clip.

23. The method of claim 21 in which guiding the users through one or more test productions is performed until a specific quality of the recording is achieved.

24. The method of claim 21 in which a number of the test productions is limited.

25. The method of claim 21 in which the adjusted parameters comprise automatically adjusted parameters.

26. The method of claim 25 in which the automatically adjusted parameters comprise playback track volume for each playback track.

27. The method of claim 21 in which the adjusted parameters comprise one or more of the group including:
input volume;
playback volume; and
total volume.

28. The method of claim 21 in which the adjusted parameters comprise special effects.

29. The method of claim 19 in which the providing the recording to the users comprises sending the recording via a Bluetooth connection to a user's Bluetooth enabled device.

30. The method of claim 19 in which the providing the recording to the users comprises producing a digital disc and providing the digital disc to the users.

31. The method of claim 20 and further comprising providing a sound insulating compartment in which to produce the media clip, wherein the display of the animated facsimile of a recording director appears to be behind a glass window.

32. The method of claim 20 and further comprising using a central management computer for remotely managing the booth.

33. The method of claim 32 in which the central management comprises blocking the booth from producing the media clips.

34. The method of claim 32 in which the central management comprises setting a limit to a number of media clips produced by the booth.

35. The method of claim 32 in which the central management includes communicating with the booth over a network.

36. The method of claim 32 in which the central management includes reading codes from the booth.

37. The method of claim 32 in which the central management includes sending codes to the booth.

38. The method of claim 32 in which the central management includes providing codes for entering to the booth.

39. The method of claim 32 in which the central management includes one or more functions from the group including:
payment monitoring;
gathering data about users;
gathering data about media clips;
blocking the system for producing a media clip from use;
changing a number of uses allowed the system for producing a media clip;
updating media clips stored by the system for producing a media clip;
updating programming of the system for producing a media clip;
gathering data about status of components of the system for producing a media clip; and
sending advertising for display by the system for producing a media clip.

40. A method for producing a media clip, providing one or more users with a recording studio experience, comprising:
providing the users with interactive guidance through test producing the media clip, the guidance being providing by interaction with a display of an animated facsimile of a recording director.

41. A method for providing a recording studio experience for participants of an event, comprising placing the booth of claim 1 at the event and enabling the participants of the event to be users of the booth.

42. The method of claim 41 in which use of the booth is provided free of charge to the participants of the event.
